(19) United States
(12) Patent Application Publication
(10) Pub. No.: US 2007/0223250 A1
(43) Pub. Date: Sep. 27, 2007

(54) Light guide plate, light deflecting element configuration and surface light source device

(75) Inventors: Ping-Yeng Chen, Feng Yuan City (TW); Chong-Yang Fang, Hsin Ying City (TW)

Correspondence Address: BIRCH STEWART KOLASCH & BIRCH, PO BOX 747, FALLS CHURCH, VA, 22040-0747, US

(73) Assignee: WINTEX CORPORATION

(21) Appl. No.: 11/599,474

(22) Filed: Nov. 15, 2006

(30) Foreign Application Priority Data
Mar. 24, 2006 (TW) 095110270

(51) Int. Cl. F21V 7/04

(52) U.S. Cl. 362/614; 362/619; 362/612; 362/625

(57) ABSTRACT

A light guide plate includes a base plate and a plurality of light deflecting elements. The light deflecting elements are formed on one surface of the base plate and arranged based on two coordinate axis directions of the surface of the base plate. Each row of the light deflecting elements substantially aligned along one coordinate axis direction has a distribution offset toward the other coordinate axis direction.

### BACKGROUND OF THE INVENTION

(a) Field of the Invention

The invention relates to a light guide plate having a base plate and a plurality of light deflecting elements formed on the base plate, and particularly to a light guide plate and its light deflecting element configuration for a point light source or linear light source.

(b) Description of the Related Art

FIG. 1 shows a schematic diagram illustrating a conventional design of a light guide plate 100 in cooperation with a point light source. The point light source, for example, is a light emitting diode (LED) 102. As shown in FIG. 1, because the radiated light from a point light source has a spherical wavefront, light deflecting elements 104 are arranged regularly on a base plate 106 along r and θ directions in a polar coordinate system to form concentric circles to let the light guide plate 100 have better light-guiding performance. Further, the longitudinal direction M of each light deflecting element 104 (the extending direction of the lengthwise side of a light deflecting element 104) is substantially perpendicular to a connecting line N running from itself to the LED 102 (δ=90°). In other words, the light deflecting elements 104 are so arranged that their longitudinal directions M are substantially perpendicular to the radiation direction of the LED 102.

Moreover, according to the conventional design, because the spatial angular distribution of the light radiated from the LED 102 is not uniform, in order to obtain better luminance uniformity, the light guide plate 100 is divided into a plurality segments corresponding to the radiation direction of the point light source, and each segment occupies a sector zone having an arc angle α between two adjacent dashed lines in FIG. 1. Thus, the distribution density of the light deflecting elements 104 in each segment is adjusted according to the actual light intensity detected in each segment so as to obtain better luminance uniformity.

However, the above conventional design apparently has the following drawbacks.

First, because each light deflecting element 104 has very small dimensions, as the light deflecting elements 104 are arranged regularly in multiple rings such as shown in FIG. 1, they are apt to be overlaid with other regularly arranged members in a liquid crystal display device, such as liquid-crystal cells, color filters, or a TFT array to generate a moiré pattern.

Further, as the light guide plate 100 is divided into a plurality of sector segments according to the conventional design, no light deflecting element 104 is found in the boundary between two adjacent segments (in the vicinity of the dashed line) from the multiple-ring arrangement. As a result, the light passing through the boundary region hardly runs into the light deflecting elements 104 and thus difficult to exit the light guide plate 100 to thereby form dark lines on the light guide plate 100, with the dark lines being formed at positions substantially coinciding with the positions of the dashed lines shown in FIG. 1.

In addition, referring to FIG. 1, since the longitudinal direction M of each light deflecting element 104 is substantially perpendicular to the radiation direction N of the LED 102, the light dispersed by the light deflecting elements 104 are over-focused to thus make themselves as bright spots whose brightness is considerably higher in contrast to surroundings. Either the dark line or the bright spot formed on the light guide plate considerably affects the visual effect of a display. Moreover, in case the light guide plate 100 is divided into a plurality of segments, the light deflecting elements that are arranged as having longitudinal direction M perpendicular to the radiation direction of an LED may cause a dense distribution in the region near the LED to restrict the adjustment of the overall luminance uniformity.

### BRIEF SUMMARY OF THE INVENTION

An object of the invention is to provide a light guide plate and a light deflecting element configuration to avoid the above mentioned problems in the conventional design.

According to the invention, a light guide plate for confining the light that is radiated from a light source along a radiation direction and emitting the light from its light emitting surface includes a base plate and a plurality of light deflecting elements. The light deflecting elements are formed on one surface of the base plate and arranged based on two coordinate axis directions of the surface of the base plate. Each row of the light deflecting elements substantially aligned along one coordinate axis direction has a distribution offset toward the other coordinate axis direction. The two coordinate axis directions may be r and 0 directions in a polar coordinate system or X-axis and Y-axis directions in a Cartesian coordinate plane. Further, the longitudinal direction of each light deflecting element may be substantially parallel to the radiation direction of the light source.

Through the design of the invention, the distribution of the row of the light deflecting elements aligned along one coordinate axis direction is offset toward the other coordinate axis direction to form a wavy irregular arrangement. Therefore, the regularity of the light deflecting element arrangement can be destroyed to avoid the formation of a moiré pattern.

Moreover, when the wavy irregular arrangement of the invention is applied to a light guide plate that is divided into a plurality of segments and has an adjustable distribution density of light deflecting elements in each segment, the light propagating in the light guide plate can run into the light deflecting elements at any position, even in the boundary between two adjacent segments. Therefore, the light passing through the boundary can be guided out of the light guide plate effectively so as to avoid the formation of dark lines.

Further, since the light deflecting element has its longitudinal direction substantially parallel to the light radiation direction, the bright spots are no longer formed to affect the visual effect because the parallel orientation of the light deflecting element does not result in over-focused light dispersion.

### BRIEF DESCRIPTION OF THE DRAWINGS

FIG. 1 shows a schematic diagram illustrating a conventional light guide plate using a point light source as a backlight.

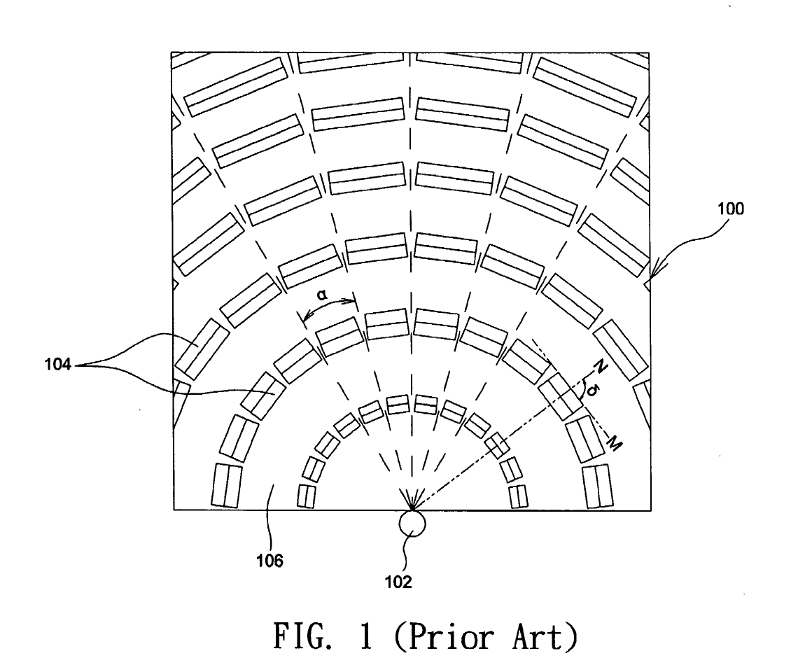

FIGS. 2A and FIG. 2B show schematic diagrams illustrating the definition for the arrangement of light deflecting elements.

FIG. 3 shows a schematic diagram illustrating a light guide plate using a point light source as a backlight according to an embodiment of the invention.

FIG. 4 shows a schematic diagram illustrating a light guide plate using a point light source as a backlight according to another embodiment of the invention.

FIG. 5 shows a schematic diagram illustrating a light guide plate using a linear light source as a backlight according to another embodiment of the invention.

FIG. 6 shows a schematic diagram illustrating a light guide plate using multiple point light sources as a backlight according to another embodiment of the invention.

FIG. 7A shows a schematic diagram illustrating a surface light source device including a light guide plate according to the invention.

FIG. 7B shows an enlarged view of a design example of light deflecting elements according to the invention.

FIG. 8 shows an enlarged view of another design example of light deflecting elements according to the invention.

FIG. 9 shows an enlarged view of another design example of light deflecting elements according to the invention.

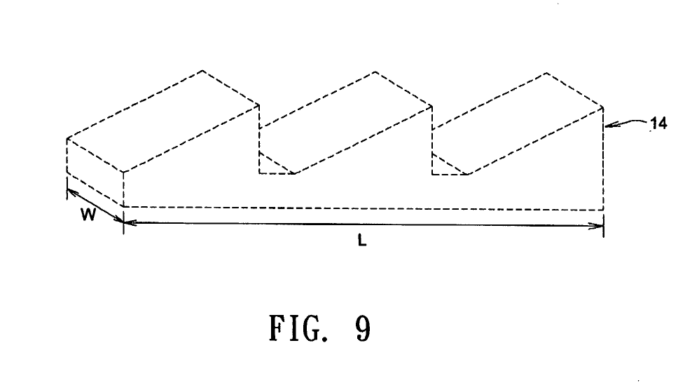

FIG. 10 shows a schematic diagram illustrating a design of additional perturbation according to an embodiment of the invention.

FIG. 11 shows a schematic diagram illustrating the normal distribution rule for designing the additional perturbation.

### DETAILED DESCRIPTION OF THE INVENTION

Herein, the rule for arranging light deflecting elements in a plane is defined as the following before the embodiments of the invention are explained.

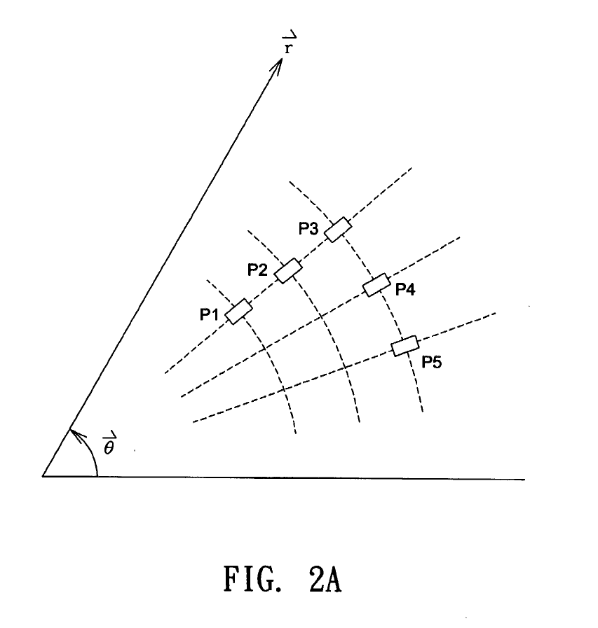

As shown in FIG. 2A, when light deflecting elements are distributed in a polar coordinate plane, an arrangement where light deflecting elements P1, P2, and P3 positioned substantially in a line is defined as “arranging along r direction (radial direction) of the polar coordinate plane”, while an arrangement where light deflecting elements P3, P4, and P5 positioned on the circumference of a concentric circle at different angles θ is defined as “arranging along θ direction (angular direction) of the polar coordinate plane”. On the other hand, as shown in FIG. 2B, when light deflecting elements are distributed in a Cartesian coordinate plane, an arrangement where light deflecting elements Q1, Q2 and Q3 positioned in a horizontal line is defined as “arranging along X-axis direction of the Cartesian coordinate plane”, while light deflecting elements Q3, Q4 and Q5 positioned in a vertical line is defined as “arranging along Y-axis direction of the Cartesian coordinate plane”.

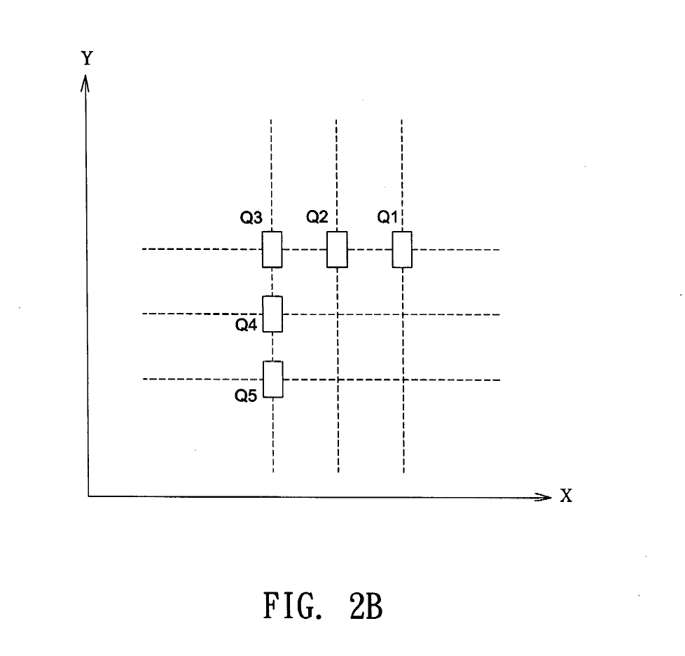

FIG. 3 shows a schematic diagram illustrating a light guide plate 10 using a point light source as a backlight according to an embodiment of the invention. The point light source, for example, is a light emitting diode (LED) 16 whose radiated light rays have a spherical wavefront. Referring to FIG. 3, in case of using a point light source, the light deflecting elements 14 are substantially arranged along r, θ directions of a polar coordinate system on the surface of a base plate 12 so as to have better light-guiding performance. Next, from FIG. 3 it can be clearly seen light deflecting elements 14 that are to be arranged along θ direction (such as the arrangement of light deflecting elements P3, P4, and P5 shown in FIG. 2A) are designed to have a positive or negative offset distance along r direction, so that they are not positioned on the circumference of the same concentric circle shown in FIG. 2A but generate a wavy irregular arrangement along θ direction, which can be clearly seen from the solid lines depicted in -FIG. 3. Note that these wavy solid lines are imagined lines depicted to help to understand the wavy irregular arrangement but not to represent any physical structure on the light guide plate 10.

In the conventional design, the regularly-arranged light deflecting elements 14 are apt to be overlaid with other members with a regular arrangement in the liquid crystal display device to generate a moire pattern. In comparison, in this embodiment, the light deflecting elements substantially arranged along θ direction have positive or negative offsets along r direction so as to generate a wavy irregular arrangement. Therefore, the regularity of the light deflecting element arrangements is destroyed to avoid the formation of a moire pattern.

Moreover, according to this embodiment, the positive or negative offset distance along r direction for a row of light deflecting elements aligned along θ direction is preferably less than 1/20 of the distance between the light source and the farthest position of the light guide plate 10 away from the light source 16.

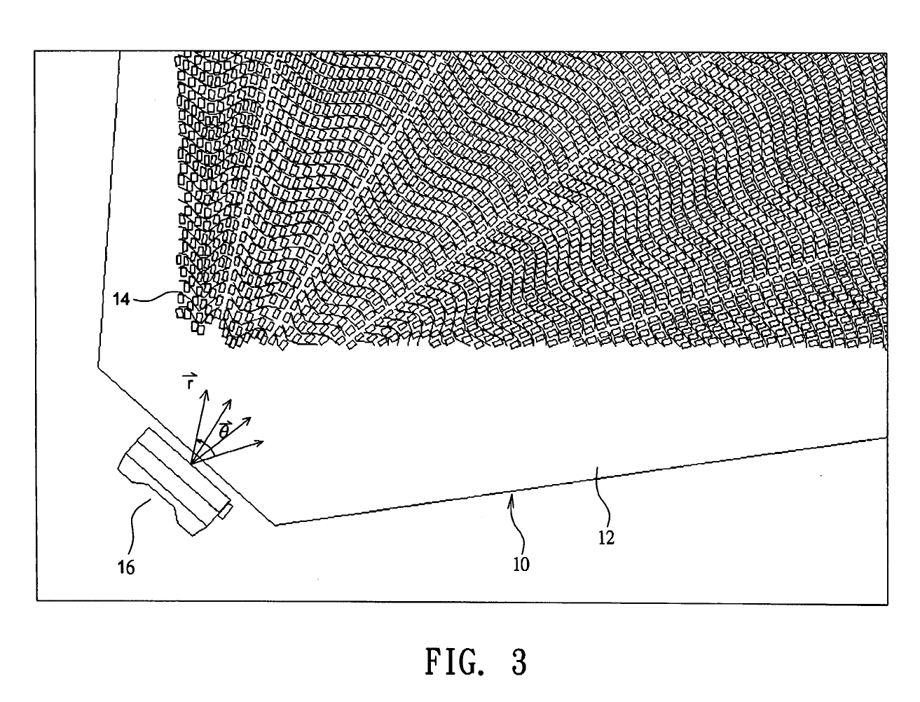

FIG. 4 shows a schematic diagram illustrating a light guide plate 10 using a point light source as a backlight according to another embodiment of the invention. According to the invention, when the light guide plate uses a point light source as a backlight, the light deflecting elements 14 aligned along one polar coordinate axis direction have distributed positions with positive or negative offsets along the other polar coordinate axis direction so as to generate an irregular arrangement. However, along which polar coordinate axis direction the light deflecting elements 14 are aligned or have offsets is not limited. For example, as shown in FIG. 4, not only the light deflecting elements 14 to be aligned along θ direction have distributed positions with positive or negative offset distances along r direction, but also the light deflecting elements 14 to be aligned along r direction have positive or negative offset angles along θ direction so as to form another wavy irregular arrangement. That is, the light deflecting elements 14 that are to be arranged along r direction (such as the arrangement of light deflecting elements P1, P2, and P3 shown in FIG. 2A) deviate from a virtual radius r so that they are not positioned on the same radius to generate a wavy irregular arrangement along r direction. The irregular propagation of light deflecting elements along r direction can be clearly seen from the imagined arc lines depicted in FIG. 4.

Thus, if the wavy irregular arrangement of the invention is applied to a light guide plate that is divided into a plurality of segments and has an adjustable distribution density of light deflecting elements in each segment, the light propagating on the light guide plate can run into the light deflecting elements 14 at any position, even in the boundary between two adjacent segments. Therefore, the light passing through the boundary can be guided out of the light guide plate 10 effectively so as to avoid the formation of dark lines.

Further, according to the invention, the positive or negative offset angle along θ direction for a row of light deflecting elements 14 aligned along r direction is preferably less than 5 degrees (within ±5 degrees).

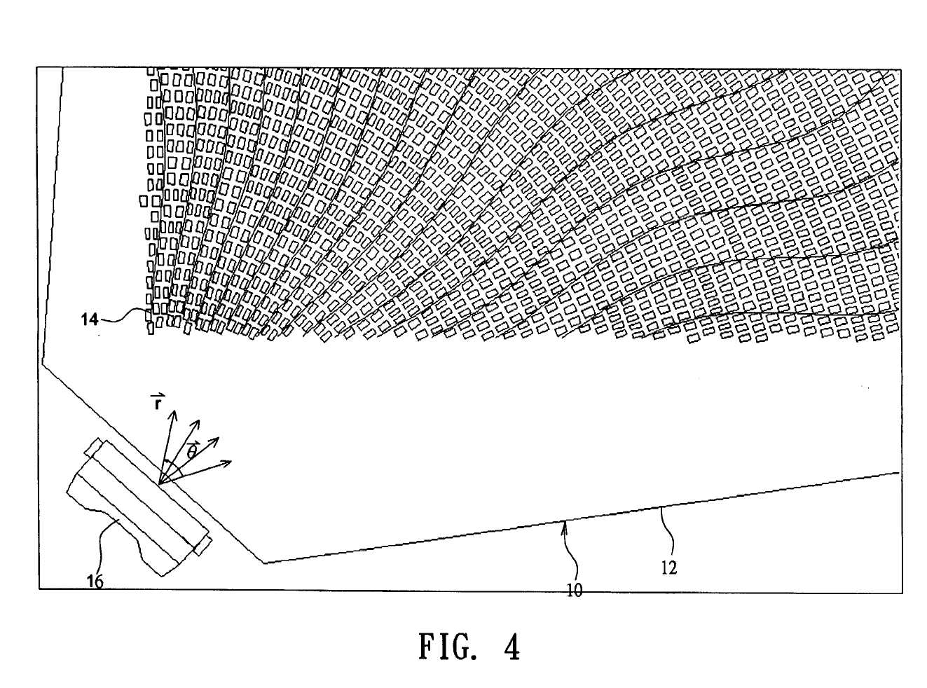

FIG. 5 shows a schematic diagram illustrating a light guide plate 10 using a linear light source as a backlight according to another embodiment of the invention. The linear light source, for example, is a cold-cathode fluorescent lamp (CCFL) 18. As shown in FIG. 5, when the backlight is selected as a linear light source, according to the invention, the light deflecting elements are substantially arranged along X-axis and Y-axis directions of a Cartesian coordinate system on the surface of the base plate 12 so as to have better light-guiding performance. Next, it can be seen from FIG. 5 that the light deflecting elements 14 to be aligned in a straight line along X-axis direction have their distributed positions with positive or negative offsets along Y-axis direction. Besides, the light deflecting elements 14 to be aligned in a straight line along Y-axis direction have their distributed positions with positive or negative offsets along X-axis direction. Therefore, the light deflecting elements provided along X-axis and Y-axis directions form a wavy irregular arrangement to destroy regularity and thus to avoid a moire pattern. Besides, the offset distance along X-axis direction for a row of light deflecting elements 14 is preferably less than 1/20 of the length of the light guide plate 10 along X-axis direction, and the offset distance along Y-axis direction is preferably less than 1/20 of the plate length along Y-axis direction.

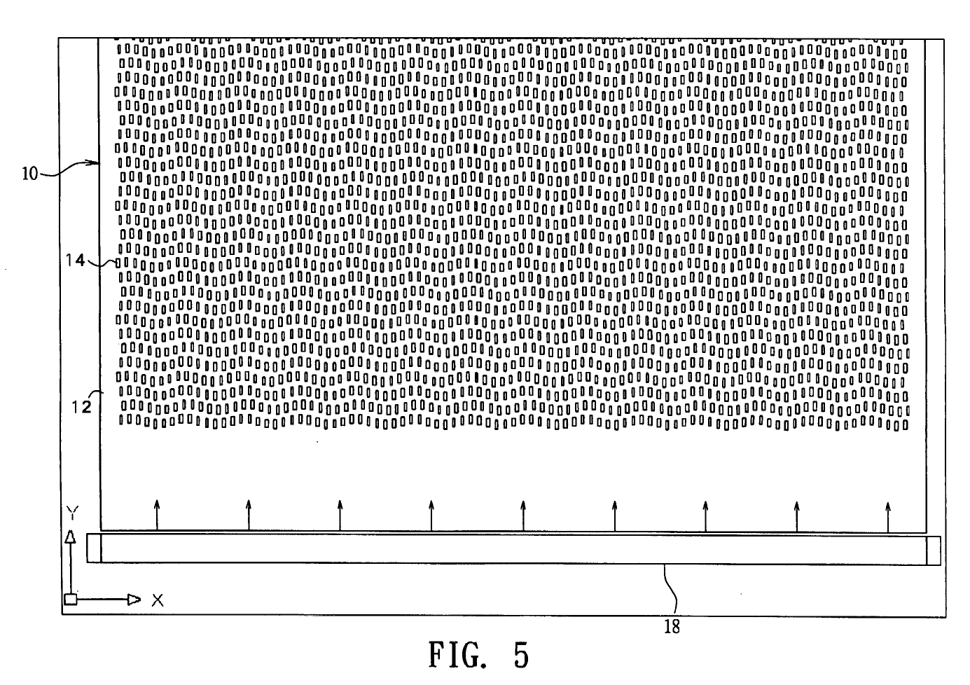

FIG. 6 shows a schematic diagram illustrating a light guide plate using multiple point light sources as a backlight according to another embodiment of the invention. According to the invention, the quantity and positions of the point light source provided on the light guide plate 10 are not limited and can be determined according to the actual demand. Referring to FIG. 6, three LEDs 16a, 16b, and 16c arranged in a row form a linear light source so as -to increase panel brightness, and the light deflecting elements 14 are arranged irregularly along X-axis and Y-axis directions on the surface of the base plate 12.

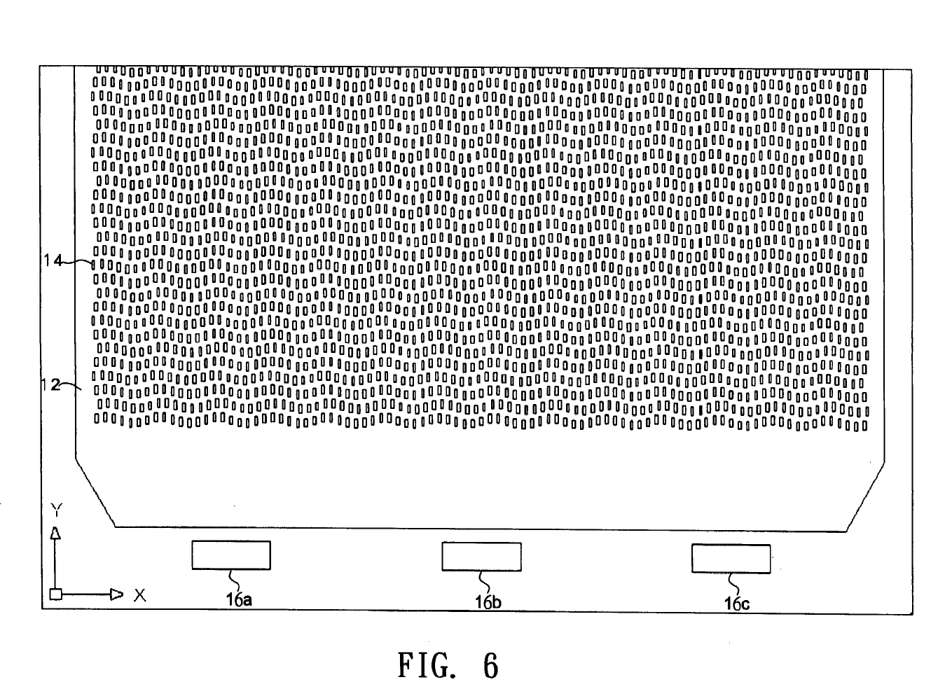

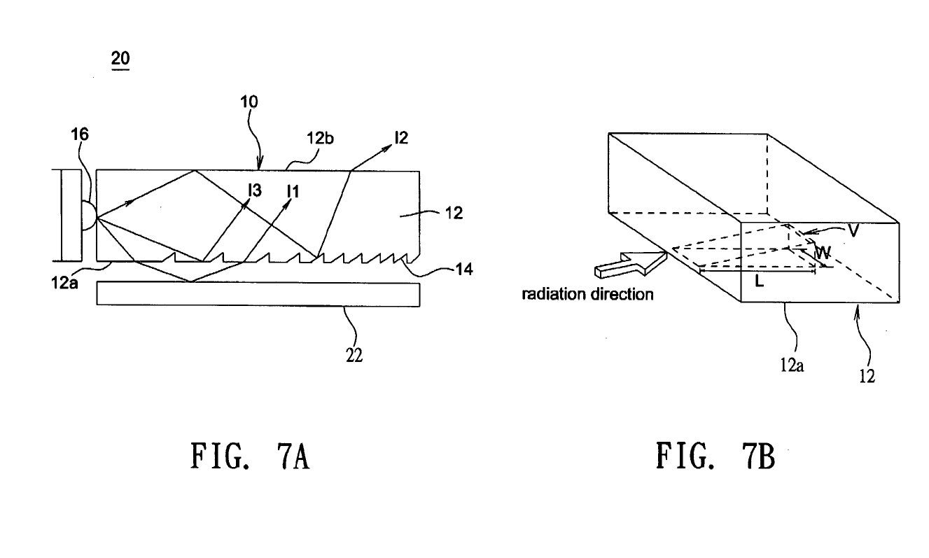

FIG. 7A shows a schematic diagram illustrating a surface light source device that includes a light guide plate of the invention. FIG. 7B shows an enlarged view of a design example of a light deflecting element according to the invention.

The surface light source device 20 includes a light guide plate 10, a reflecting plate 22, and a light source. The light source may be a point light source like an LED 16 or a linear light source like a CCFL 18. The light guide plate 10 includes a base plate 12 and a plurality of groove structures, functioning as the light deflecting elements 14, formed on the bottom surface 12a of the base plate 12. The reflecting plate 22 provided next to the bottom side of the light guide plate 16 may be a resin plate having a high reflectivity. Referring to FIG. 7A, the light rays radiated from the LED 16 are guided to and then confined in the light guide plate 10 through different paths. For example, the light ray 12 incident to the light deflecting elements 14 are diffused by the light deflecting elements 14 to emerge out of the light guide plate 10 via the top surface 12b; on the other hand, the light rays without immediately coming across the light deflecting elements 14 have two possible paths, as indicated by the light rays I1 and I3 shown in FIG. 7A. The light ray I1 emerging out of the bottom surface 12a of the light guide plate 10 is reflected back by the reflecting plate 22 and then confined in the light guide plate 10 again. In comparison, the light ray I3 is totally reflected by the bottom surface 12a of the light guide plate 10 and confined in the light guide plate 10. Thus, the surface light source device 20 continually confines the light rays radiated from the light source therein and then diffuses them to allow for surface emission transmitted from the light emitting surface (i.e. top surface 12b) of the light guide plate 10. In addition, it can be seen from FIG. 7A that the distribution density of the light deflecting elements 14 on the bottom surface of the light guide plate 10 increases along with the increase of the distance away from the light source (LED 16) so as to improve the brightness uniformity of the light guide plate 10.

The formation of the light guide plate 10 according to the invention is not limited to a specific material; for example, it may be made of transparent resin with high refractive index. Also, the method for forming the light guide plate 10 is not limited to a specific manner. For example, a light guide master mold with a protruded microstructure (not shown), which is formed by the processes of exposure, developing, deposition, and electroforming, is used to form the light guide plate 10. After resin materials are injected into the light guide master mold, a one-piece light guide plate having light deflecting elements 14 is formed through thermal pressing.

Referring to FIG. 7B, the light deflecting element 14 is a V-shaped groove structure V curved inward on the bottom surface 12a of the base plate 12. According to an embodiment of the invention, the longitudinal direction of a groove structure V (the extending direction of the lengthwise side L) is substantially parallel to a connecting line running from itself to an LED; that is, the longitudinal direction of a groove structure V is substantially parallel to the radiation direction of an LED. Under the circumstance, the distance between two adjacent light deflecting elements is reduced, and bright spots are no longer formed to affect the visual effect because the parallel orientation of the groove structure V does not result in over-focused light dispersion. In addition, as shown in FIG. 4, when the light guide plate is divided into multiple segments to assist in the uniformity of light intensity, the region near the LED 16 of each segment may accommodate a larger number of groove structures V that have a longitudinal direction parallel to the radiation direction of the LED 16 to allow for a fine adjustment of the brightness uniformity. The length of the groove structure V along the longitudinal direction is preferably within 0.1 um-500 um.

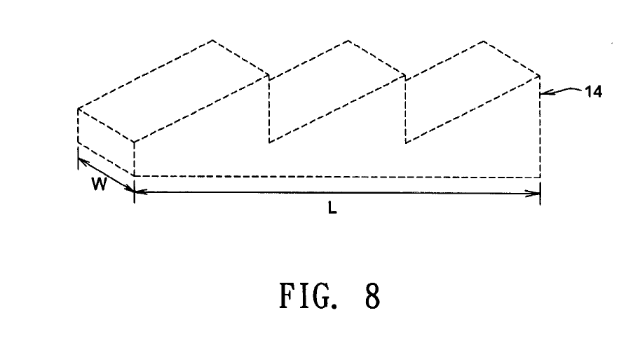

Besides, the groove structure V is not limited to V-shaped and can be cylindrical as long as efficient light diffusion effect is achieved. FIG. 8 shows another design of the light deflecting element 14 that integrates a plurality of shallow V-shaped micro-grooves sharing a common slot; in that case, the light deflecting element 14, under the same dimension, may have a shallower indented surface to further reduce the possibility of forming bright spots. Moreover, the shallow V-shaped micro-grooves that share a common slot are not limited in a continuous distribution shown in FIG. 8; alternatively, they may be discretely distributed with a gap between two adjacent micro-grooves. The length of the V-shaped micro-groove along the longitudinal direction is preferably within 0.01 um-250 um.

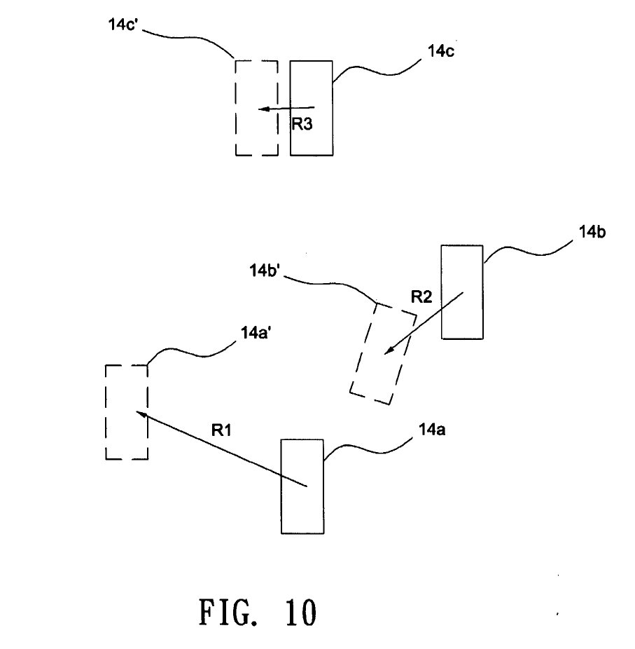

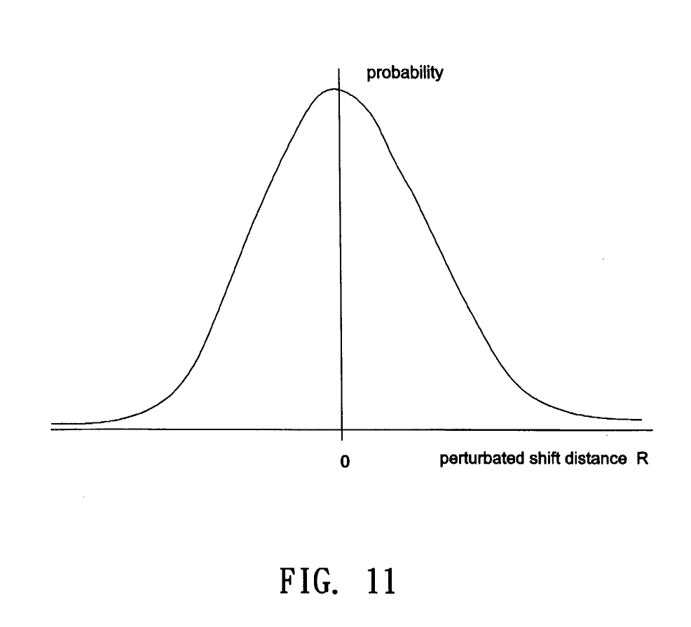

The design for enhancing the effect of avoiding a moire pattern and dark lines will be described in the following. As show in FIG. 10, the light deflecting elements 14a, 14b, and 14c substantially aligned along one coordinate axis direction have a distribution offset along the other coordinate axis direction to form a wavy irregular arrangement. Next, on the basis of the wavy irregular arrangement, a certain degree of perturbation for the distribution offset is carried out to further increase the irregularity of the arrangement of the light deflecting elements so as to enhance the effect of avoiding a moire pattern and dark lines. However, such perturbation must be confined by the rule of normal distribution shown in FIG. 11 to prevent an over-randomized distribution. For clarity, the displacement of each light deflecting element 14 away from its original position (predetermined offset position deviated from a virtual radius r or from a virtual concentric circle) should follow the normal distribution; in other words, the probability of a longer distance between the perturbed position and the original position is lower, while the probability of a shorter distance between the perturbed position and the original position is higher. For example, in the case shown in FIG. 10, the light deflecting elements 14a, 14b, and 14c having an distribution offset along the other coordinate axis direction are further perturbed to be shifted with distances R1, R2, and R3 (R1>R2>R3) to the positions of light deflecting elements 14a′, 14b′, and 14c′, respectively, and the probability of shifting the light deflecting element 14a to the light deflecting element 14a′ (a high degree of perturbation accompanied by a longer shift distance) is smaller while the probability of shifting the light deflecting element 14c to the light deflecting element 14c′ (a low degree of perturbation accompanied by a shorter shift distance) is larger. Therefore, due to the additional perturbation design of the invention, the irregularity of the arrangement of the light deflecting elements is further increased but will not reach an over-randomized degree.

While the invention has been described by way of examples and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A light guide plate for confining the light that is radiated from a light source along a radiation direction and emitting the light from its light emitting surface, the light guide plate comprising:
a base plate; and
a plurality of light deflecting elements formed on one surface of the base plate, wherein the light deflecting elements are arranged based on two coordinate axis directions of the surface of the base plate and each row of the light deflecting elements substantially aligned along one coordinate axis direction has a distribution offset toward the other coordinate axis direction.

2. The light guide plate as claimed in claim 1, wherein the longitudinal direction of each light deflecting element is substantially parallel to the radiation direction.

3. The light guide plate as claimed in claim 1, wherein the light guide plate is made of resin with high refractive index.

4. The light guide plate as claimed in claim 1, wherein the distribution density of the light deflecting elements on the light guide plate increases along with the increase of the distance away from the light source.

5. The light guide plate as claimed in claim 1, wherein the distribution offset for each row of the light deflecting elements follows a normal distribution.

6. The light guide plate as claimed in claim 1, wherein the two coordinate axis directions are r and θ directions in a polar coordinate system and the row of the light deflecting elements substantially aligned along the r direction has a positive or negative distribution offset along the θ direction.

7. The light guide plate as claimed in claim 6, wherein the positive or negative offset angle along the θ direction for the row of the light deflecting elements substantially aligned along the r direction is less than 5 degrees.

8. The light guide plate as claimed in claim 1, wherein the two coordinate axis directions are r and 0 directions in a polar coordinate system and the row of the light deflecting elements substantially aligned along the θ direction has a positive or negative distribution offset along the r direction.

9. The light guide plate as claimed in claim 8, wherein the positive or negative offset distance along the r direction for the row of the light deflecting elements substantially aligned along the θ direction is less than 1/20 of the distance between the light source and the farthest position of the light guide plate away from the light source.

10. The light guide plate as claimed in claim 1, wherein the two coordinate axis directions are X-axis and Y-axis directions in a Cartesian coordinate system and the row of the light deflecting elements substantially aligned along the X-axis direction has a positive or negative distribution offset along the Y-axis direction.

11. The light guide plate as claimed in claim 10, wherein the positive or negative offset distance along the Y-axis direction is less than 1/20 of the length of the light guide plate along the Y-axis direction.

12. The light guide plate as claimed in claim 1, wherein the two coordinate axis directions are X-axis and Y-axis directions in a Cartesian coordinate system and the row of the light deflecting elements substantially aligned along the Y-axis direction has a positive or negative distribution offset along the X-axis direction.

13. The light guide plate as claimed in claim 12, wherein the positive or negative offset distance along the X-axis direction is less than 1/20 of the length of the light guide plate along the X-axis direction.

14. The light guide plate as claimed in claim 1, wherein the distribution areas of the light deflecting elements on the light guide plate are divided into a plurality of segments and the distribution density of the light deflecting elements in each segment is determined according to detected detected light intensity in each segment.

15. The light guide plate as claimed in claim 1, wherein the light source is a linear light source or a point light source.

16. A light deflecting element configuration, comprising:
a plurality of light deflecting elements formed on a base plate, wherein the light deflecting elements are arranged based on two coordinate axis directions in a plane and each row of the light deflecting elements aligned substantially along one coordinate axis direction has a distribution offset toward the other coordinate axis direction.

17. The light deflecting element configuration as claimed in claim 16, wherein the distribution of the light deflecting elements forms a wavy irregular arrangement.

18. The light deflecting element configuration as claimed in claim 16, wherein the distribution offset for each row of the light deflecting elements follows a normal distribution.

19. The light deflecting element configuration as claimed in claim 16, wherein the two coordinate axis directions are r and θ directions in a polar coordinate system or X-axis and Y-axis directions in a Cartesian coordinate plane.

20. The light deflecting element configuration as claimed in claim 16, wherein each light deflecting element comprises a groove structure and the length of the groove structure along its longitudinal direction is 0.1 um-500 um.

21. The light deflecting element configuration as claimed in claim 20, wherein the groove structure is formed by a plurality of light deflecting microstructures that share a common slot and the length of each light deflecting microstructure along its longitudinal direction is 0.01 um-250 um.

22. A surface light source device, comprising:
a light source;
a light guide plate for confining the light radiated from a light source and and emitting the light from its light emitting surface, wherein the light guide plate comprises a plurality of light deflecting elements formed thereon and arranged based on two coordinate axis directions in a plane and each row of the light deflecting elements substantially aligned along one coordinate axis direction has a distribution offset toward the other coordinate axis direction; and
a reflecting plate provided next to one side of the light guide plate opposite to the light emitting surface for reflecting the light from the light guide plate back into the light guide plate.

23. The surface light source device as claimed in claim 22, wherein the distribution of the light deflecting elements forms a wavy irregular arrangement.

24. The surface light source device as claimed in claim 22, wherein the two coordinate axis directions are r and θ directions in a polar coordinate system or X-axis and Y-axis directions in a Cartesian coordinate system.
